(19) United States
(12) Patent Application Publication
(10) Pub. No.: US 2008/0151544 A1
(43) Pub. Date: Jun. 26, 2008

(54) ILLUMINATING DEVICE

(75) Inventors: Tomoya TABUCHI, Higashiomi (JP); Hidetaka Katou, Higashiomi (JP)

Correspondence Address: PROCOPIO, CORY, HARGREAVES & SAVITCH LLP, 530 B STREET, SUITE 2100, SAN DIEGO, CA, 92101, US

(73) Assignee: Kyocera Corporation, Kyoto (JP)

(21) Appl. No.: 11/959,130

(22) Filed: Dec. 18, 2007

(30) Foreign Application Priority Data
Dec. 20, 2006 (JP) 2006-342602

(51) Int. Cl. F21V 7/06

(52) U.S. Cl. 362/246

(57) ABSTRACT

An illuminating device includes a plurality of light-emitting diodes, a plurality of first light-reflecting parts, and a plurality of second light-reflecting parts. Each of the plurality of first light-reflecting parts has a first light reflecting surface surrounding one of the light-emitting diodes. Each of the plurality of second light-reflecting parts has a second light reflecting surface surrounding one of the light-emitting diodes. The shape of the first light reflecting surface is different from that of the second light reflecting surface.

### CROSS-REFERENCE TO RELATED APPLICATION

This application claims priority under 35 U.S.C. §119 to Japanese Application No. 2006-342602, filed Dec. 20, 2006, titled ILLUMINATING DEVICE, which is hereby incorporated by reference.

### BACKGROUND

1. Field of the Invention

The present invention relates to illuminating devices including light-emitting diodes.

2. Description of the Related Art

Recently, illuminating devices including light-emitting diodes have been developed. Illuminating devices including light-emitting diodes are small and have long lives, and are therefore expected as future illuminating devices. An illuminating device including a plurality of light-emitting diodes has been developed. Such an illuminating device illuminates an irradiation region with light generated by the plurality of light-emitting diodes.

### SUMMARY OF THE INVENTION

According to an aspect of the present invention, an illuminating device includes a plurality of light-emitting diodes, a plurality of first light-reflecting parts, and a plurality of second light-reflecting parts. Each of the plurality of first light-reflecting parts has a first light reflecting surface surrounding one of the light-emitting diodes. Each of the plurality of second light-reflecting parts has a second light reflecting surface surrounding one of the light-emitting diodes. The shape of the first light reflecting surface is different from that of the second light reflecting surface.

According to another aspect of the present invention, an illuminating device includes a plurality of light sources, converting means, and light-flux forming means. The plurality of light sources emit visible light. The converting means converts the visible light from the light sources into substantially parallel light. The light-flux forming means emits the visible light as a non-parallel light flux.

According to another aspect of the present invention, an illuminating device includes a first light-emitting part and a second light-emitting part. The first light-emitting part emits first light. The second light-emitting part emits second light having a dispersibility different from that of the first light.

### BRIEF DESCRIPTION OF THE DRAWINGS

FIG. 1 is an exploded view illustrating an illuminating device according to an embodiment of the present invention;

FIG. 2 is a plan view of the illuminating device illustrated in FIG. 1;

FIG. 3 is a sectional view of the illuminating device illustrated in FIG. 2 taken along line III-III′;

FIG. 4 is a longitudinal sectional view illustrating a light-emitting diode that can be used in the embodiment;

FIG. 5 illustrates an arrangement of light reflecting parts;

FIG. 6 illustrates the shape of a first light reflecting surface;

FIG. 7 illustrates the shape of a second light reflecting surface;

FIG. 8 illustrates the shape of light emitted from a second light-reflecting part on a virtual plane;

FIG. 9 illustrates an irradiation region of the illuminating device;

FIG. 10 illustrates the shape of a second light reflecting surface in an illuminating device according to another embodiment of the present invention;

FIG. 11 is a plan view of an illuminating device according to another embodiment of the present invention;

FIG. 12 illustrates an arrangement of light reflecting parts in the illuminating device illustrated in FIG. 11; and

FIG. 13 illustrates an irradiation region of the illuminating device illustrated in FIG. 11.

### DESCRIPTION OF THE PREFERRED EMBODIMENTS

An illuminating device 1 according to a first embodiment of the present invention will now be described with reference to the accompanying drawings. The illuminating device 1 includes a substrate 101, a plurality of light-emitting diodes 102, and a reflector 103. The substrate 101 has a conductive pattern 101c that is electrically connected to the light-emitting diodes 102. The conductive pattern 101c is also electrically connected to a power source line 105.

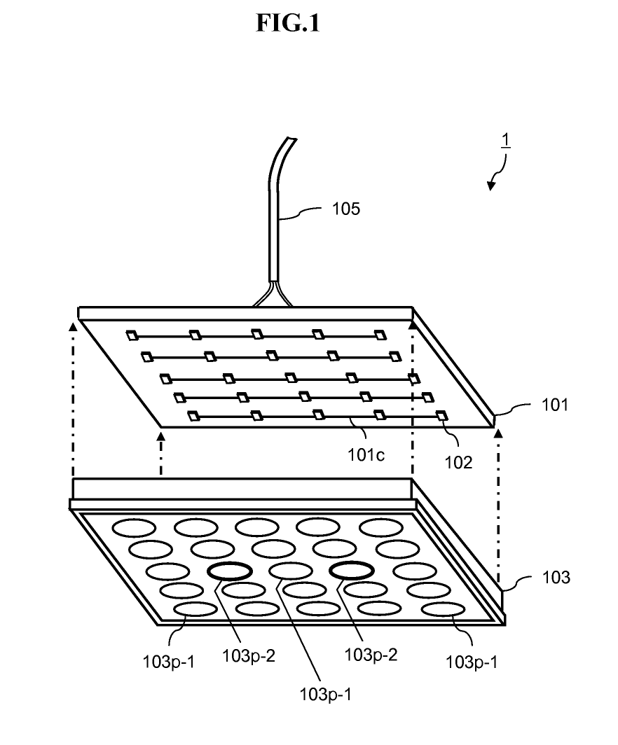

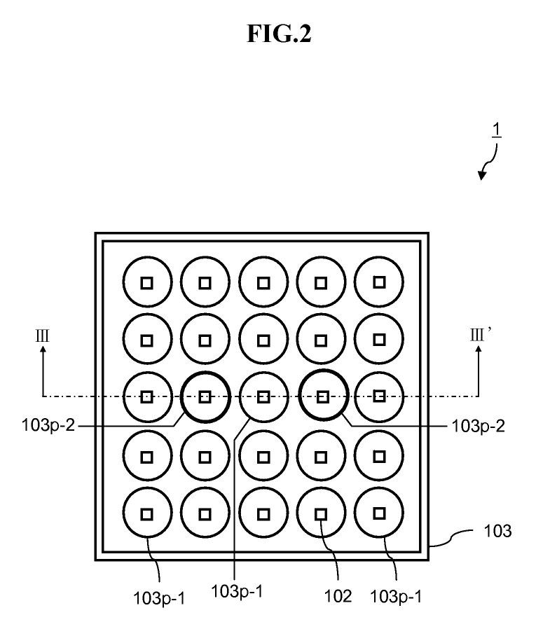

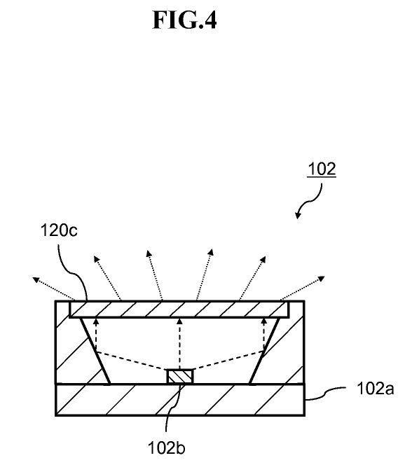

The light-emitting diodes 102 are mounted on the substrate 101, and are electrically connected to the conductive pattern 101c. In the present embodiment, “light-emitting diode” means a light-emitting diode lamp or a light-emitting diode chip. The light-emitting diodes 102 shown in FIGS. 1 to 3 are light-emitting diode lamps. Another example of a light-emitting diode is a white-light-emitting diode chip. The light-emitting diodes 102 are light sources that emit visible light. As shown in FIG. 4, each of the light-emitting diodes 102 includes a base 102a, a light-emitting diode chip 102b, and a light emitter 102c. The base 102a is a package. Another example of the base 102a is a flat plate. The light-emitting diode chip 102b is made of a semiconductor material, and emits blue light or ultraviolet light. The light emitter 102c converts the wavelength of light emitted from the light-emitting diode chip 102b. The light emitter 102c may generate red light, green light, and blue light. The light emitter 102c has a transparent base material and a fluorescent material contained in the base material. The “transparency” of the base material means that at least a part of light emitted from the light-emitting diode chip 102b is allowed to pass therethrough. The fluorescent material is excited by the light emitted from the light-emitting diode chip 102b. The light-emitting diode 102 emits mixed light, i.e., white light.

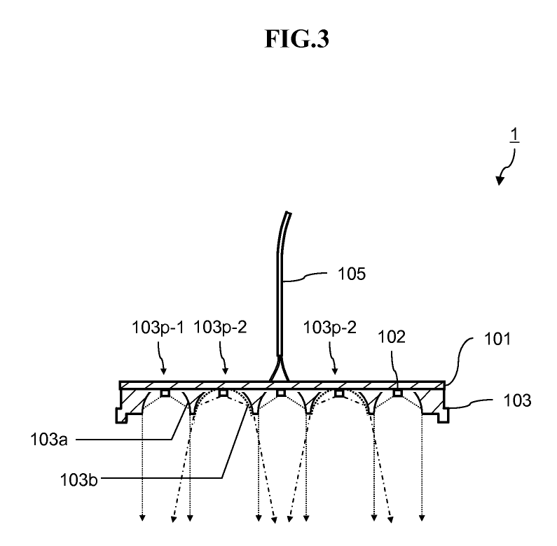

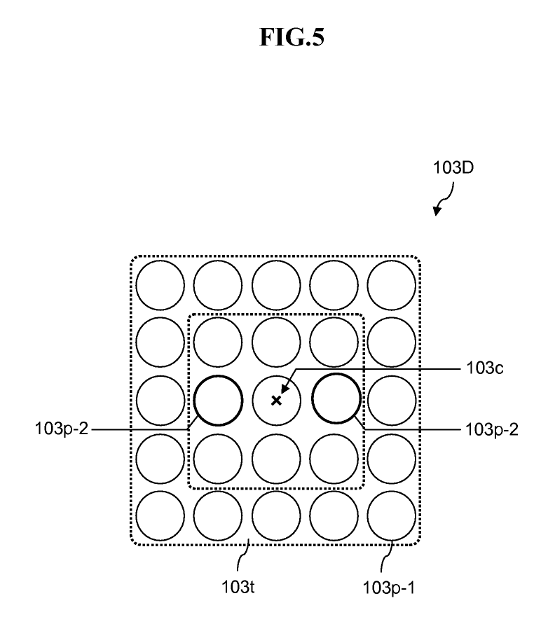

The reflector 103 has a plurality of light reflecting parts. The light reflecting parts include a plurality of first light-reflecting parts 103p-1 and a plurality of second light-reflecting parts 103p-2. The first light-reflecting parts 103p-1 emit first light. The second light-reflecting parts 103p-2 emit second light having a dispersibility different from that of the first light. The first light-reflecting parts 103p-1 are two-dimensionally arranged. As shown in FIG. 3, each of the first light-reflecting parts 103p-1 has a first light reflecting surface 103a surrounding one of the light-emitting diodes 102. Each of the second light-reflecting parts 103p-2 has a second light reflecting surface 103b surrounding one of the light-emitting diodes 102. The first light reflecting surfaces 103a of the first light-reflecting parts 103p-1 and the second light reflecting surfaces 103b of the second light-reflecting parts 103p-2 are arranged in accordance with the light-emitting diodes 102. As shown in FIG. 5, the second light-reflecting parts 103p-2 are arranged symmetrically about an arrangement center 103c of the first light-reflecting parts 103p-1. The second light-reflecting parts 103p-2 are disposed inside an outermost periphery 103t of an overall arrangement 103D of the first light-reflecting parts 103-p1 and the second light-reflecting parts 103-p2. The first light-reflecting parts 103-p1 are disposed along the outermost periphery 103t of the overall arrangement 103D. In FIG. 5, two second light-reflecting parts 103-p2 are surrounded by twenty three first light-reflecting parts 103p-1.

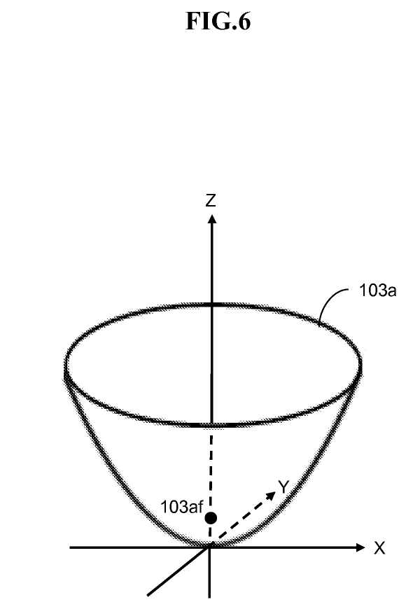

The shape of each of the second light reflecting surfaces 103b is different from that of each of the first light reflecting surfaces 103a. As shown in FIG. 6, each of the first light reflecting surfaces 103a is a parabolic surface. The “parabolic surface” is a quadric surface obtained by rotating a parabola around an axis of symmetry Z. In FIG. 6, the XYZ coordinates are orthogonal coordinates. One of the light-emitting diodes 102 (not shown) is disposed at a focus 103af of the parabolic surface. The first light reflecting surfaces 103a collimate and reflect light emitted from the light-emitting diodes 102. The first light reflecting surfaces 103a convert the visible light emitted from the light sources into substantially parallel light. In other words, the first light-reflecting parts 103p-1 serve as converting means that converts the visible light from the light sources into substantially parallel light.

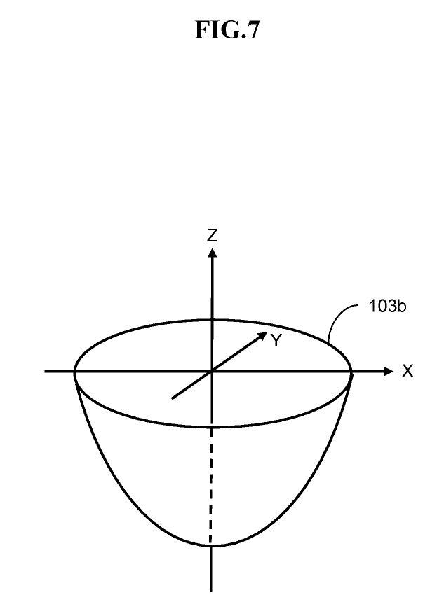

As shown in FIG. 7, each of the second light reflecting surfaces 103b is an ellipsoidal surface. The “ellipsoidal surface” is a quadric surface expressed as follows:

(x²/a²)+(y²/b²)+(z²/c²)=1

Each of the second light reflecting surfaces 103b is a spheroid surface with respect to the Z axis. In FIG. 7, the XYZ coordinates are orthogonal coordinates. Each of the second light-reflecting parts 103p-2 emits annular light.

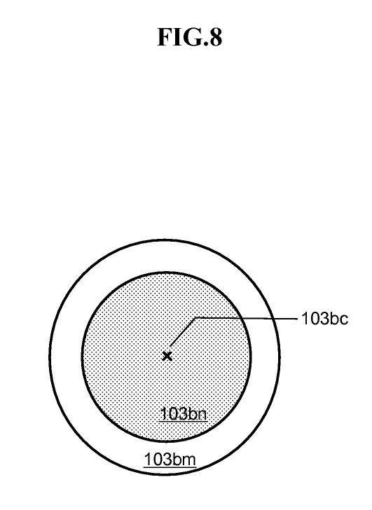

Referring to FIG. 8, the “annular light” means light having an annular high-illuminance region 103bm in the irradiation region. The illuminance in a region 103bn including the center 103bc of the irradiation region and surrounded by the region 103bm is smaller than the illuminance in the region 103bm. The irradiation region refers to a region irradiated by light on a virtual plane (for example, a plane 10 cm away from the light-emitting diode 102). The second light reflecting parts 103p-2 serve as light-flux forming means that emits the visible light from the light sources as a non-parallel light flux.

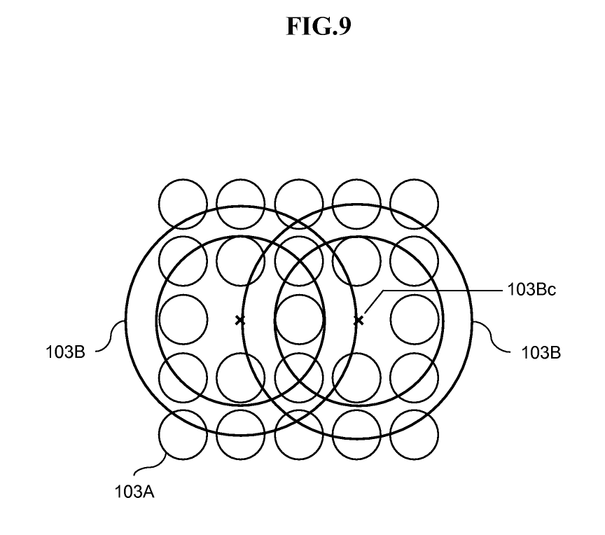

As shown in FIG. 9, in the irradiation region, light beams 103B emitted from the second light-reflecting parts 103p-2 overlap light beams 103A emitted from the first light-reflecting parts 103p-1. Thus, the light beams 103B and the light beams 103A overlap one another. The light beams 103b may or may not overlap each other. A center of the light beams 103B is shown by reference numeral 103Bc. The illuminating device 1 emits mixed light of the light beams 103A emitted from the first light-reflecting parts 103p-1 and light beams 103B emitted from the second light-reflecting parts 103p-2. The illuminating device 1 includes the second light reflecting surfaces 103b having a curved shape that is different from the shape of the first light reflecting surfaces 103a. Therefore, the illuminance uniformity is improved in the irradiation region. That is, two kinds of lights with different dispersibility make the illuminance more uniform in the irradiation region.

The second light reflecting surfaces 103b are preferably rougher than the first light reflecting surfaces 103a. The first light reflecting surfaces 103a may be mirror surfaces. The second light reflecting surfaces 103b are light-scattering surfaces. Light emitted from each of the second light-reflecting parts 103p-2 is diffused light. The “diffused light” refers to light having a lower directionality than that of light reflected by each of the first light reflecting surfaces 103a. The illuminating device 1 includes the second light reflecting surfaces 103b having a surface state different from that of the first light reflecting surfaces 103a. Therefore, the illuminance uniformity is improved in the irradiation region.

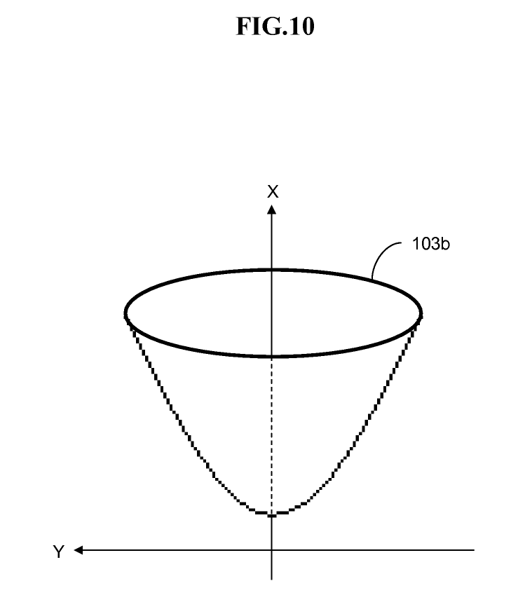

An illuminating device 1 according to second embodiment of the present invention will now be described. The second embodiment differs in the shape of the second light reflecting surfaces 103b from the first embodiment. The second light reflecting surface 103b is a hyperboloidal surface in the second embodiment. Referring to FIG. 10, the “hyperboloidal surface” is a quadric surface obtained by rotating a hyperbola around an axis of symmetry X. The hyperbola is expressed as follows:

x²/a²−y²/b²=1

Each of the second light-reflecting parts 103p-2 having the second light reflecting surfaces 103b emits annular light. Light beams emitted from the second light-reflecting parts 103p-2 overlap light beams emitted from the first light-reflecting parts 103p-1. The illuminating device 1 includes the second light reflecting surfaces 103b having a curved shape that is different from the shape of the first light reflecting surfaces 103a. Therefore, the illuminance uniformity is improved in the irradiation region. The second light reflecting surfaces 103b are light-scattering surfaces. Light emitted from each of the second light-reflecting parts 103p-2 is diffused light.

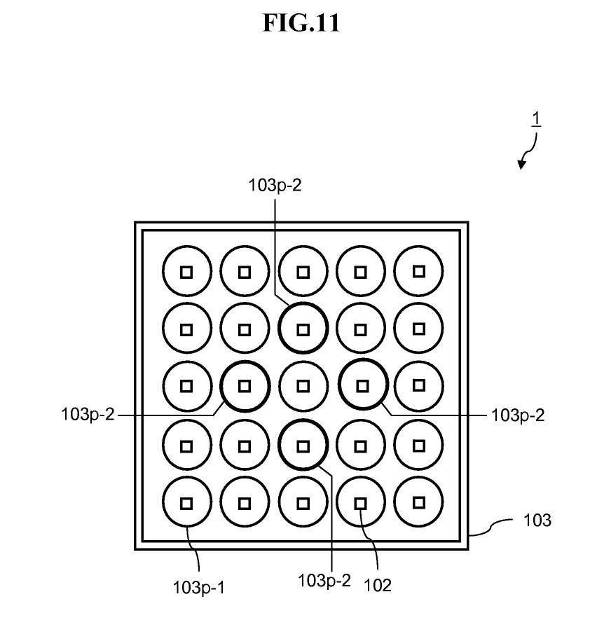

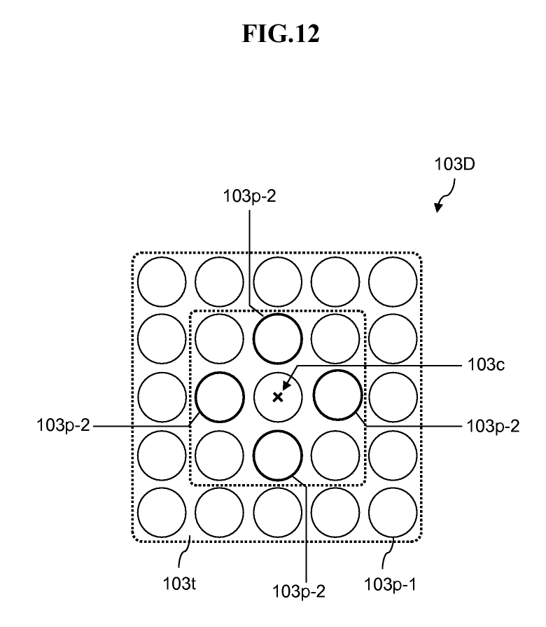

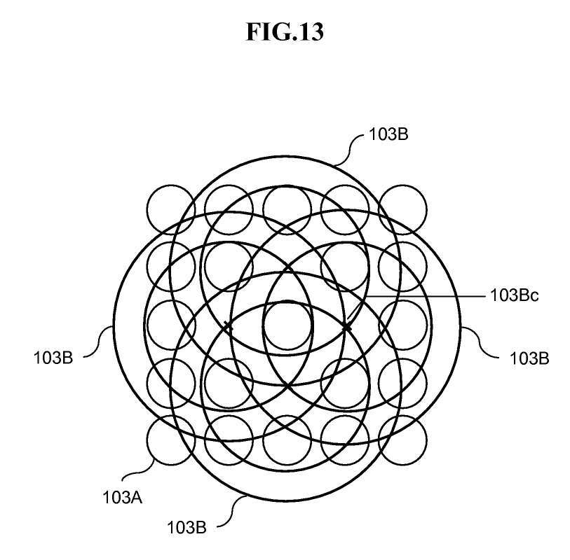

An illuminating device 1 according to third embodiment of the present invention will now be described with reference to FIG. 11. The third embodiment differs in the number of the second light-reflecting parts 103-p2 and their arrangement from the first embodiment. As shown in FIG. 12, four second light-reflecting parts 103p-2 are arranged symmetrically about an arrangement center 103c of first light-reflecting parts 103p-1. The second light-reflecting parts 103p-2 are disposed inside an outermost periphery 103t of an overall arrangement 103D of the first light-reflecting parts 103-p1 and the second light-reflecting parts 103-p2. The first light-reflecting parts 103-p1 are disposed along the outermost periphery 103t of the overall arrangement 103D. The second light-reflecting parts 103-p2 are surrounded by the first light-reflecting parts 103p-1. In the illuminating device 1 according to the present embodiment, the illuminance uniformity is improved in the irradiation region as shown in FIG. 13.

The present invention is not limited to the above-described embodiments. In addition, various modifications are possible within the scope of the present invention.

For example, each of the light reflecting surfaces may be constituted of a plurality of surfaces. More specifically, each of the light reflecting surfaces may be constituted as a combination of a plurality of polygonal surfaces.

In addition, the light reflecting surfaces may include a light reflecting surface having no light-emitting diode. In reverse, the light-emitting diodes may include a light-emitting diode that is not surrounded by a light reflecting surface.

Moreover, the numbers of first light-reflecting parts and second light-reflecting parts or their ratio is not particularly limited. In addition, third (fourth, fifth, sixth, . . . ) light reflecting parts having third (fourth, fifth, sixth, . . . ) light reflecting surfaces whose shape differs from those of the first and second light reflecting surfaces may also be provided. The different arrangement of the overall arrangement 103D may be used. That is, instead of square shape shown in FIG. 1, the shape of the overall arrangement may be other polygonal shapes such as hexagon or octagon, circular or round shape.

1. An illuminating device comprising:
a plurality of light-emitting diodes;
a plurality of first light-reflecting parts, each of which has a first light reflecting surface surrounding one of the light-emitting diodes, and
a plurality of second light-reflecting parts, each of which has a second light reflecting surface surrounding one of the light-emitting diodes,
wherein the shape of the first light reflecting surface is different from that of the second light reflecting surface.

2. The illuminating device according to claim 1, wherein the second light-reflecting parts are symmetrically arranged about an arrangement center of the light reflecting surfaces.

3. The illuminating device according to claim 2, wherein the first light-reflecting parts are two-dimensionally arranged.

4. The illuminating device according to claim 3, wherein the second light-reflecting parts are two-dimensionally arranged.

5. The illuminating device according to claim 1, wherein the first light reflecting surface is a parabolic surface.

6. The illuminating device according to claim 5, wherein the second light reflecting surface is an ellipsoidal surface.

7. The illuminating device according to claim 5, wherein the second light reflecting surface is a hyperboloidal surface.

8. The illuminating device according to claim 5, wherein the second light reflecting surface is a light-scattering surface.

9. The illuminating device according to claim 1, wherein the second light-reflecting parts emit annular light.

10. The illuminating device according to claim 9, wherein the first light-reflecting parts emit parallel light.

11. The illuminating device according to claim 1, wherein the second light-reflecting parts emit diffused light.

12. The illuminating device according to claim 11, wherein the first light-reflecting parts emit parallel light.

13. The illuminating device according to claim 1, wherein light emitted from the second light-reflecting parts overlaps light reflected by the first light reflecting surfaces.

14. An illuminating device comprising:
a plurality of light sources that emit visible light;
converting means configured to convert the visible light from the light sources into substantially parallel light; and
light-flux forming means configured to emit the visible light as non-parallel light flux.

15. The illuminating device according to claim 14, wherein the light sources are two-dimensionally arranged.

16. An illuminating device comprising:
a first light-emitting part that emits first light; and
a second light-emitting part that emits second light having a dispersibility different from that of the first light.

17. The illuminating device according to claim 16, wherein the first light is parallel light.

18. The illuminating device according to claim 17, wherein the second light is at least one of annular light and diffused light.

19. The illuminating device according to claim 16, wherein the first light and the second light are mixed with each other.
